(19) United States
(12) Patent Application Publication
(10) Pub. No.: US 2011/0258069 A1
(43) Pub. Date: Oct. 20, 2011

(54) Non-Monetary Trading System

(76) Inventor: Barbara Basham, Austin, TX (US)

(21) Appl. No.: 13/086,587

(22) Filed: Apr. 14, 2011

Related U.S. Application Data
(60) Provisional application No. 61/324,276, filed on Apr. 14, 2010.

(51) Int. Cl. G06Q 30/00

(52) U.S. Cl. 705/26.3

(57) ABSTRACT

Systems and methods that enable users to trade items such as clothing and accessories through non-monetary exchanges. In one embodiment, a web site system enables trading of items based upon a point system that is similar to an auction, but no money is exchanged. Points are given to users in exchange for items that are traded away, and points are traded in for desired items. Effectively, in order to obtain one item, another item has to be traded away. The web site enables automated searching and other functions based upon personal information associated with users. The web site also provides opportunities for either unused items or points to be traded (donated) to charitable organizations.

### CROSS-REFERENCE TO RELATED APPLICATIONS

This application claims the benefit of U.S. Provisional Patent Application 61/324,276, filed Apr. 14, 2010, which is incorporated by reference as if set forth herein in its entirety.

### BACKGROUND

1. Field of the Invention

The invention relates to computer systems and methods that enable users to trade items such as clothing and accessories through non-monetary exchanges.

2. Related Art

When people buy new items, such as clothing or accessories, these items are typically the purchasers' favorites and are used or worn quite extensively. As the “newness” wears off, they are used less and, at some point, they may be put into a closet or other storage space, where they may remain indefinitely. Other items may be seasonal, and may only be used for a few months out of the year. Still other items may be in fashion when they are first purchased, but then become less fashionable, and consequently less used. Items that are unused often accumulate, taking up more and more storage space. The owners of these items may keep the items in storage because they forget about them, because they do not want to throw away items that are in perfectly good condition, or for similar reasons. If the items are not used however, they are simply taking up space, and do the owners no good.

Because these unused items may still be in good condition, they may be of use to someone other than the owner. Moreover, there may be someone other than that owner who would appreciate these items as if they were new. For instance, if one person purchased a dress and accessories for a particular occasion, but had no further use for these items after that occasion, the owner's friend might be happy to have the dress and/or accessories for a similar occasion. In fact, some groups of friends (typically women) may trade clothing and accessories because one friend has tired of a particular item, while another friend has admired the item and would enjoy using it. By trading these items among friends, the items get more use and do not simply take up storage space. Additionally, the friends obtain items that are “new” to them, without having to spend any money to get them.

### SUMMARY OF THE INVENTION

This disclosure is directed to systems and methods that solve one or more of the problems discussed above. In one particular embodiment, in order to expand the concept of trading items among friends, a web site system has been developed to facilitate trading of items that are no longer used. The web site enables trading of items based upon a point system that is similar to an auction, but no money is exchanged. Points are given to users in exchange for items that are traded away, and points are traded in for desired items. Effectively, in order to obtain one item, another item has to be traded away. The web site provides expanded opportunities to trade items because the group of users is much larger than the small groups of friends that typically trade items with one another. The web site also provides opportunities for either unused items or points to be traded (donated) to charitable organizations.

### BRIEF DESCRIPTION OF THE DRAWINGS

Other objects and advantages of the invention may become apparent upon reading the following detailed description and upon reference to the accompanying drawings.

FIG. 1 is a diagram illustrating the physical architecture of a system in accordance with one embodiment.

FIG. 2 is a diagram illustrating an exemplary architecture of the system application.

FIG. 3 shows an exemplary registration web page through which a user can enter information in one embodiment.

FIG. 4 is an exemplary web page for entering information about an item to be traded in one embodiment.

FIG. 5 is a web page illustrating items that are available for bids in one embodiment.

FIG. 6 is an exemplary web page illustrating a wish list in one embodiment.

FIG. 7 is a web page illustrating the detail for a first matching item in a wish list in one embodiment.

FIG. 8 is an exemplary web page illustrating a form for entering search terms in one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DESCRIPTION OF EXEMPLARY EMBODIMENTS

One or more embodiments of the invention are described below. It should be noted that these and any other embodiments described below are exemplary and are intended to be illustrative of the invention rather than limiting.

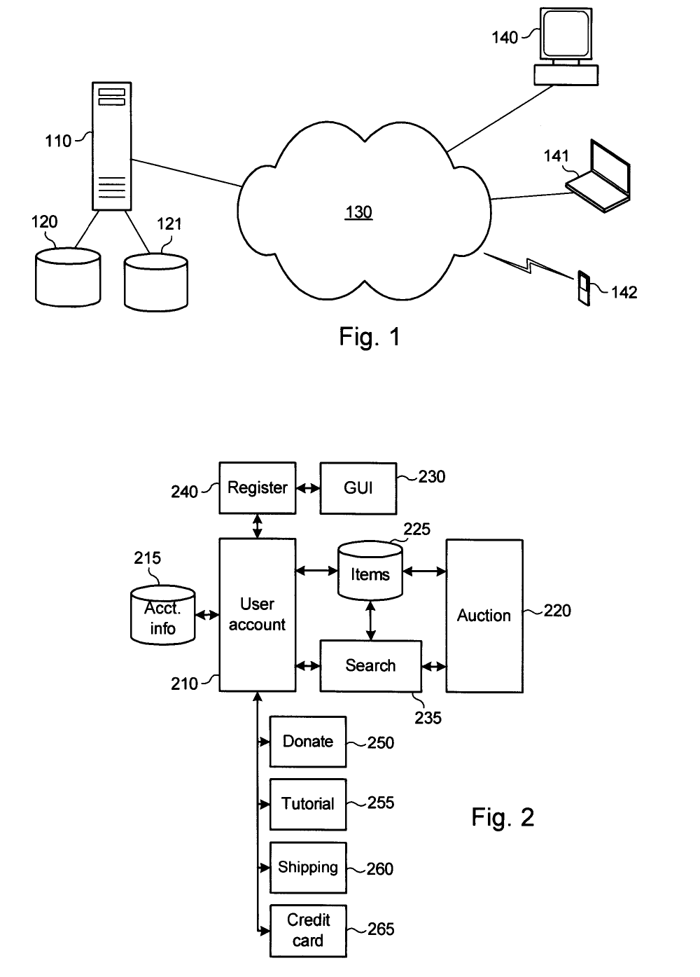

Referring to FIG. 1, a diagram illustrating the physical architecture of a system in accordance with one embodiment of the system is shown. In this embodiment, various program modules that support the web site are resident on a server 110. The program modules provide the functionality that is implemented in the system, such as registration functions, auction functions, communication functions, etc. Server 110 is coupled to one or more data storage units 120 and 121. Data storage units 120 and 121 may store user account information, auction item information, and various other types of information that are necessary to the operation of the system. Server 110 is coupled to a network 130 to allow communications between users (on computers, web-enabled phones or other devices 140-142) and the server. Network 130 may be any suitable type of network, such as the Internet, a local area network (LAN), or a wireless network.

The system may be implemented in many different ways, but an exemplary implementation will be described below. In this embodiment, as noted above, the system is set up as a web site that is accessible to users through a network such as the Internet. The functionality of the web site is provided by various program modules. FIG. 2 is a diagram illustrating an exemplary architecture of the system application.

As depicted in FIG. 2, the system is built around a user account module 210 and an auction module 220. A graphical user interface (GUI) module 230 allows users to access the system and intuitively navigate the various features of the system. When a user first registers with the system, a registration module 240 obtains the necessary information from the user and communicates with user account module 210 to set up an account for the user. The information for the account is maintained in an account information storage 215.

Users can add items to be traded using user account module 210. The item information is maintained in item information storage 225. The trading of the items for points is handled through auction module 220. Users can search for items that are being traded using search module 235, which interacts with information storage 225 and auction module 220. Search module 235 may automatically search for items that match user preferences that are identified using user account module 210 and account information storage 215.

The system may also include modules that handle ancillary functions. For instance, when items are traded from their original owners to other users, the items may need to be physically shipped to the new owners. In this embodiment, a shipping module 260 manages the transfer of information necessary to ship the item. This module may be authorized by individual users to access credit card information, address information, etc., as needed to ship the item to the new owner. Another function that may be included in the system is the capability to donate either items or points to a charitable organization. Donation module 250 handles such donations and may maintain records of the donations and provide reports to administrators, users and charitable organizations. Still another function that is depicted in FIG. 2 is represented by tutorial module 255. This module may provide users with access to instructions for using the system, FAQ's, instructional videos, and the like. A credit card module 265 is implemented in order to allow people to pay membership fees, authorized shipping charges, etc.

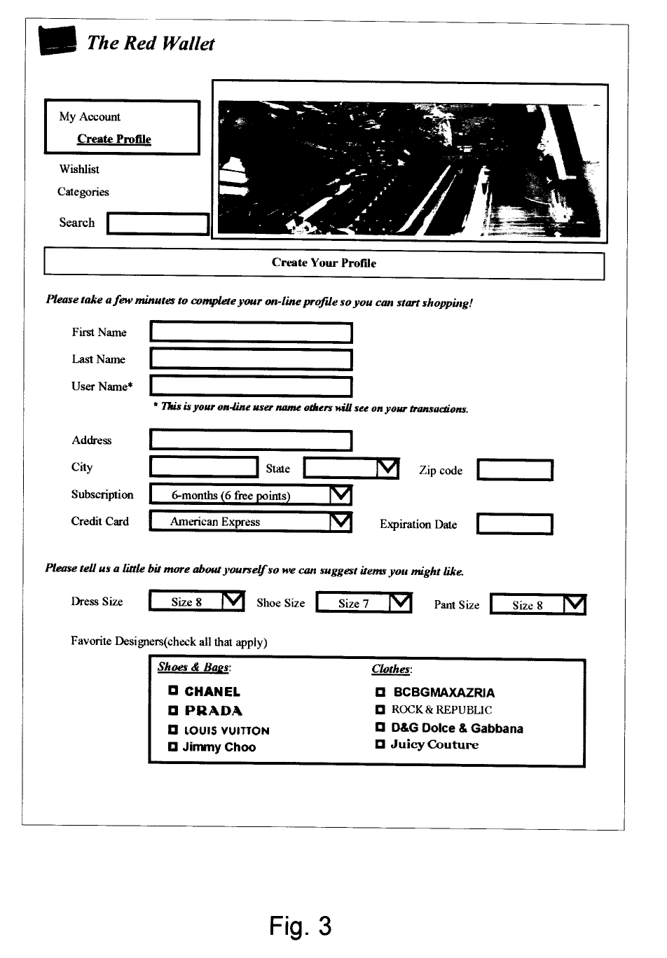

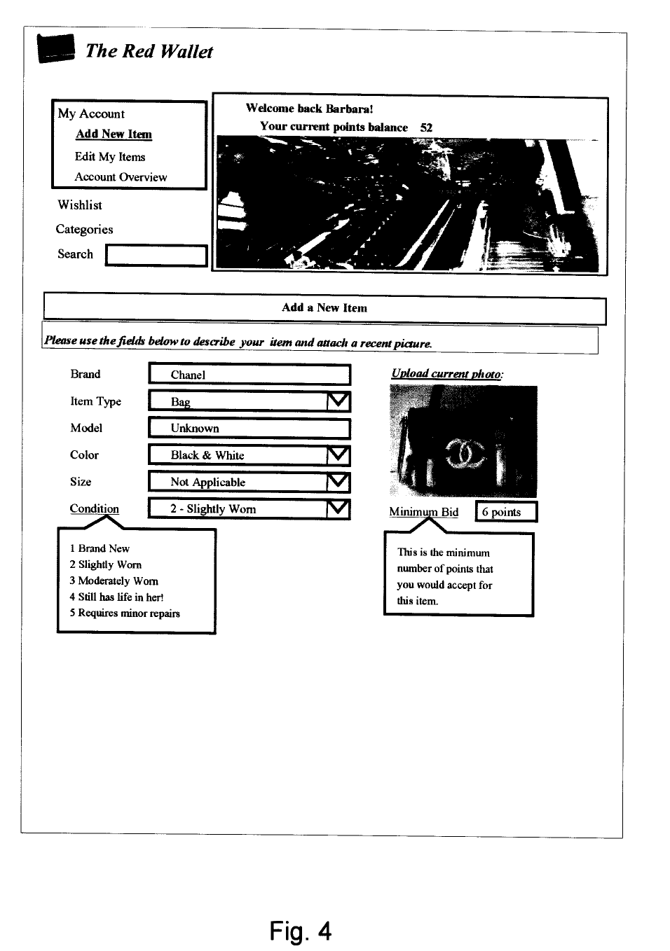

Users may interact with the system described above in the following manner. FIGS. 3-8 show exemplary web pages that are presented to the users in order to facilitate the functions and interactions referenced below.

In one embodiment, the system is a membership web site. That is, a person must be registered as a member of the system before the person can use the web site. References herein to “users” should be construed as references to registered members. FIG. 3 shows an exemplary registration web page through which a user can enter information and thereby register with the system. When a person registers as a member of the system, the system typically obtains credit card information, although membership fees can also be paid by check, bank transfer, or other means. When the person is initially registered in the system, a predetermined number of points are allocated to the person's user account. The number of points that are allocated to the account may depend upon the type or length of membership that is purchased, how the membership fees are paid, and so on. For instance, 10 points may be allocated to the account for a six-month membership, or 20 points may be allocated for a 12-month membership. Similarly, a smaller number of points may be allocated to a limited-access account, while a larger number of points may be allocated to a full-access account. Pre-payment of membership fees may be rewarded with additional points over month-to-month payment plans.

In this embodiment, additional points are credited to a user's account as a result of items that are traded away by the user—the user cannot purchase additional points. This is intended to encourage users to trade their unused items on the system, rather then using the system only to acquire additional items. It is contemplated that additional points may occasionally be obtained through promotions (e.g., being awarded points for registering additional users).

When a user registers with the system, they provide various pieces of information. Some of these are similar to the information provided in other systems, such as a user name, password, e-mail address, etc. Other pieces of information are more specific to this system. For example, the user may provide information that specifies the types of items that the user would like to acquire. This information may include brand names, specific items or categories of items, sizes, colors, and so on. The user account module is configured to allow the user to update this information at any time.

Some of the information may be private, while other pieces of information may be made public by the user, if desired. The system may also allow pieces of information to be shared with specified users or groups of users, such as a circle of friends or trusted users. Thus, a user may have a “wish list” of desired items that may be shared with other users. Some of the information may also be used by the system to filter information that is provided to the user. For instance, the user may wear a size 8 shoe, so the system may use this information to filter the list of items that are available for trade, so that only size 8 shoes are displayed to the user. Conversely, the user may specify particular brands, categories or items that are not desired, and these items may be filtered from the list so that they are not displayed to the user.

As noted above, a user can trade items to other users in exchange for points. The item may be made available under the user's username, or it may be anonymous. Referring to FIG. 4, an exemplary web page for entering information about an item is shown. This web page allows the user to enter such information as the category, item, color, size, brand and condition of the item. The web page also allows the user to enter a photo of the item and to specify a minimum number of points for which the item will be traded. The item may be an individual item, or it may be a bulk item, such as an outfit (e.g., dress, shoes, handbag), a group of similarly sized clothes (e.g., boys size 12 winter clothes), or other items that will be traded as a group. Although not shown in the figure, the user may also specify a time period during which the item will be available for bidding. During this time, other users who are interested in obtaining the item may submit bids (in points) for the item.

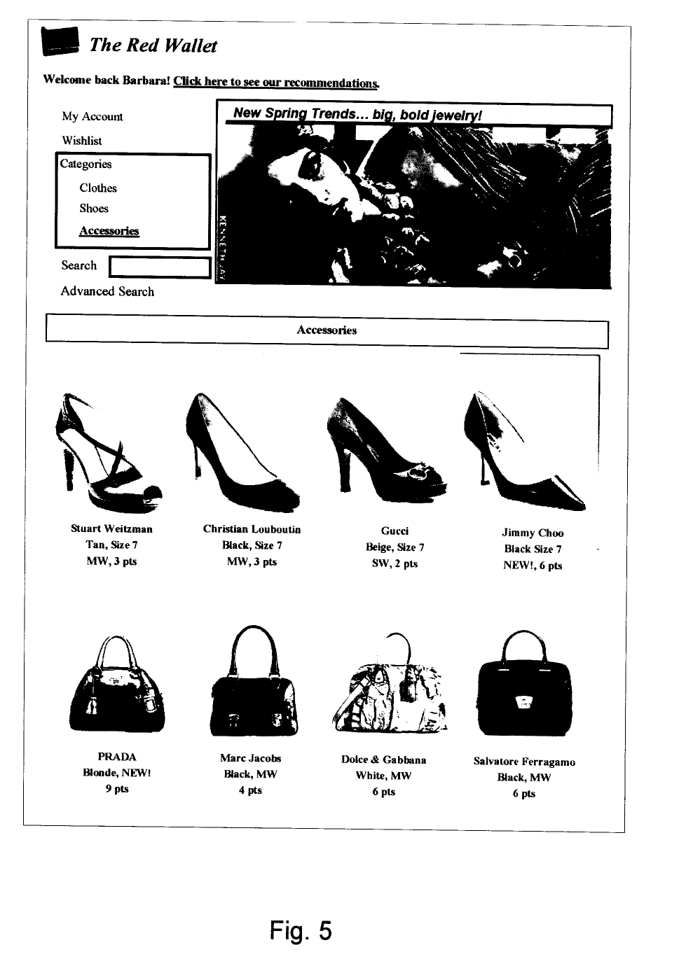

Referring to FIG. 5, a web page illustrating items that are available for bids is shown. In this case, the web page represents the items shown to a user who has indicated that she is interested in obtaining shoes and handbags. The user may have previously indicated that she wears size 7 shoes, so only shoes in that size are shown on the web page. The items shown on the web page may also have been filtered to show only desired brands, or items that can be obtained for a desired number of points. As noted above, the user's preference information can be edited at any time, so the filtering of available items can be modified. This may be helpful, for example, if the user wishes to trade for items that will be given to other people as gifts.

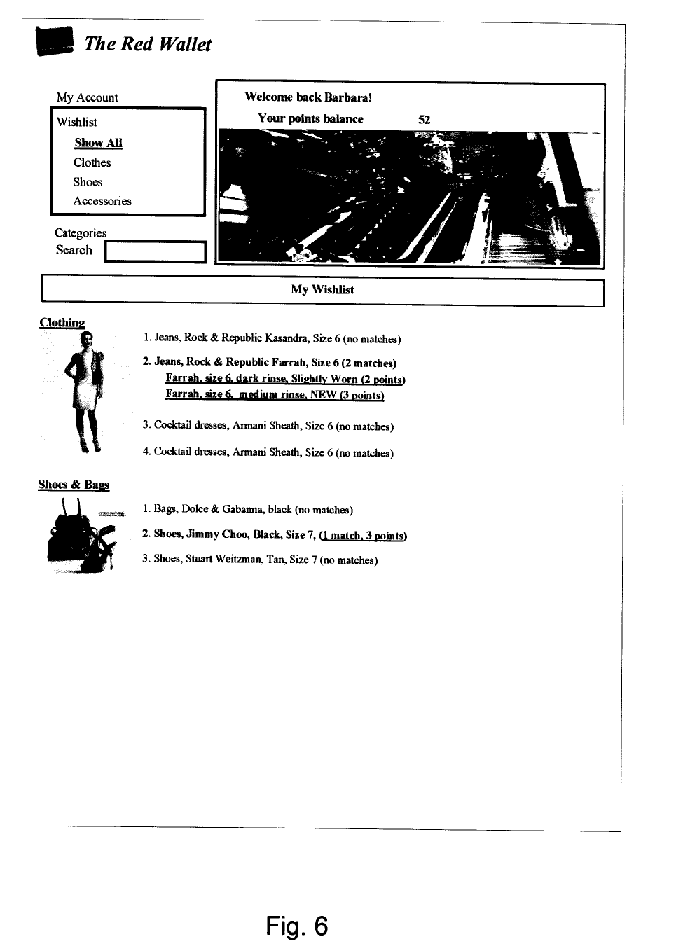

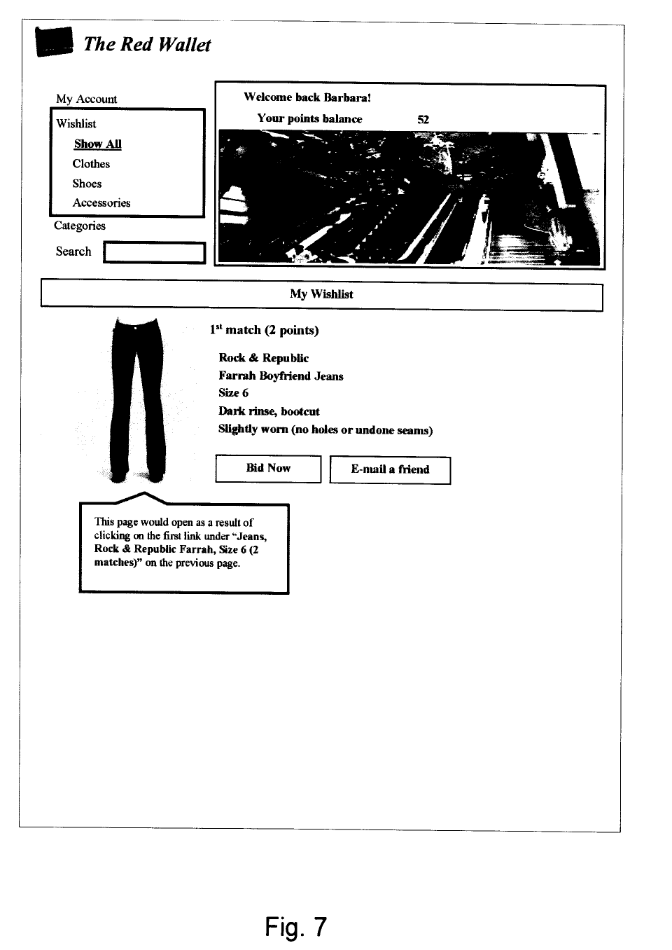

As mentioned above, a user may create a “wish list” of desired items. An exemplary web page illustrating a wish list is shown in FIG. 6. As depicted in this figure, the user has listed various items of clothing, as well as shoes and handbags. While the items included in the illustrated wish list are relatively specific, identifying category (jeans), brand (Rock & Republic), model (Farrah) and size (6), broader items can also be listed, such as simply “Jeans” or any item by “Rock & Republic”.

The system compares the items on the wish list to items that are available for bids from other users, and identifies whether or not there are any matches between the wish list and the available items. In this example, there are two matches for clothing item 2 (“Jeans, Rock & Republic Farrah, Size 6”). The matches for this item are listed below the item in the wish list. Each of the matching available items identifies how many points are required to trade for the item. It can also be seen that there is a match for one of the items under “Shoes & Bags”.

In one embodiment, the system is designed to notify the user when items matching the user's wish list become available. Notifications can be provided to the user in a variety of ways, such as emails, text messages, automated voice messages, or indicators that appear when the user logs on to the system. Similar notifications can be provided for other purposes as well, such as to notify a user when a bid has been received for that user's item, or when bidding has closed for the item.

In this embodiment, the web page is designed so that available items which match the wish list are presented as hyperlinks. The hyperlink allows the user to jump to another web page that provides additional information on the available item. For example, referring to FIG. 7, a web page illustrating the detail for the first matching item under the “Clothing” heading is shown. In addition to showing detailed information about the available item, the web page also has two buttons. The first button allows the user to place a bid on the item. The second button allows the user to send an e-mail to a friend regarding the item. The e-mail may be pre-formatted to include the detailed information on the item.

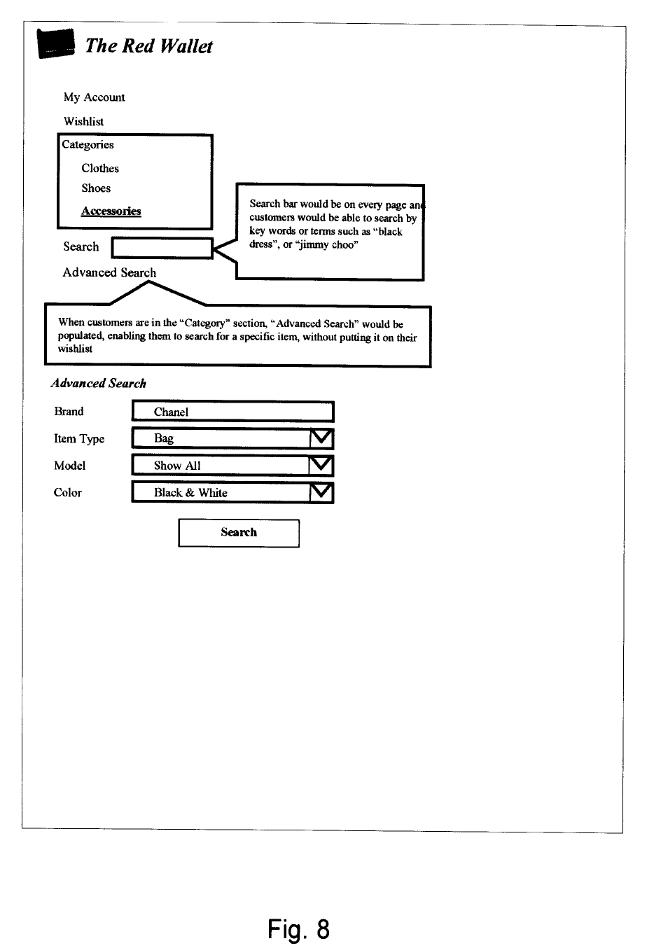

One embodiment of the web page allows users not only to find matches for items on their wish lists, but also to make specific queries for desired items. Referring to FIG. 8, an exemplary web page illustrating a form for entering search terms is shown. This form allows users to quickly select brands, item types, models and colors for a search of available items matching these requirements. Search bars may also be included on this and other pages to allow users to perform more basic text searches for available items. Additionally, search bars may be provided to allow users to search outside the present system. This would allow the users to research particular items, brands, etc.

As described above, one embodiment implements a points-based option for the available items. Users may bid for items, with the user bidding the highest number of points winning the item. In other embodiments, the system may simply set up a trade between the owner of the item and the first person who is willing to trade the desired number of points for the item. When it has been determined which user gets the item (i.e., the highest bidder or first to trade the desired number of points), the system notifies both the person trading away the item, and the person who will receive the item. In one embodiment, a shipping module facilitates the physical transfer of the item between users by presenting the winning bidder with possible shipping options. These may include shipping via U.S. Postal Service, UPS, FedEx, or other delivery services. The user may provide payment information, after which the delivery service may be scheduled to pick up the item from the original owner so that it can be shipped to the new owner. The new owner may be given the option of paying the delivery service using credit card information that has already been provided to the system upon registration of the user.

Another possible feature of the system is a mechanism for making donations. There are several types of donations that can be made. For instance, if one user would like to bid on an item, but doesn't have enough points, another user (e.g. a friend of the first user) may donate points to the first user. Another example is a donation to a charitable or nonprofit organization. Users may donate either points or items to such organizations that are registered with the system. If items are donated to the organization, the organization may trade away the items in the same manner as other users in order to obtain points. After the points are obtained, or if points are donated to the organization, the organization may bid on items using the points in the same manner as other users. And organization that provides services to the homeless could, for example, trade the points for clothing or other items that are appropriate to be given to the homeless.

The system may include various tools to assist the users in identifying items that they would like to obtain. For instance, the system may be configured to recognize brand names, model names or other types of identifying information and to provide hyperlinks for Internet searches on this information. For example, if an item is described as “Jeans, Rock & Republic Farrah, Size 6”, the system may identify the brand “Rock & Republic” and convert this text in the description to a hyperlink, so that if the user clicks on the hyperlink, it will perform an Internet search on “Rock & Republic”. Another tool that could be useful to users is a size converter. For instance, if a first user provides a description of an available item that includes a European size, it would be helpful to users who are considering bidding on this item to be able to convert the European size to an American size. Still another tool that can be provided is a member rating system that allows users to obtain feedback on other users with whom they may trade items. For example, if a user trades an item using a description of the item as being in good condition, but the item is actually in very poor condition, a user who obtains the item and discovers this mis-description can provide feedback indicating that other users should be wary of descriptions posted by the first user. Conversely, if the first user provides the item in better condition than described, the second user can provide feedback indicating that the traded item was in better-than-stated condition.

Another feature that can be provided by the system is a social networking feature. Using this feature, users can identify other users who have similar tastes, who are in the same geographic area, or have something else in common, so that the users can discuss items that are available, items that are of interest, and so on. For example, users may form groups that include friends whom they know personally, or people who are in their own neighborhood. The users can, if desired, form groups and carry on discussions within these groups or even use the system to trade exclusively within these groups.

Those of skill will appreciate that the various illustrative logical blocks, modules, circuits, and algorithm steps described in connection with the embodiments disclosed herein may be implemented as electronic hardware, computer software (including firmware,) or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in software (program instructions) executed by a processor, or in a combination of the two. Software may reside in RAM memory, flash memory, ROM memory, EPROM memory, EEPROM memory, registers, hard disk, a removable disk, a CD-ROM, or any other form of storage medium known in the art. Such a storage medium containing program instructions that embody one of the present methods is itself an alternative embodiment of the invention. One exemplary storage medium may be coupled to a processor, such that the processor can read information from, and write information to, the storage medium. In the alternative, the storage medium may be integral to the processor. The processor and the storage medium may reside, for example, in an ASIC. The ASIC may reside in a user terminal. The processor and the storage medium may alternatively reside as discrete components in a user terminal or other device.

Alternative embodiments may include software program products comprising computer-readable storage media that contain one or more instructions configured to cause a computer to perform a method as described above. The computer-readable storage medium may include any of a number of storage media, such as RAM, ROM, flash memory, EPROM memory, EEPROM memory, registers, hard disks, removable disks, CD-ROMs, optical media and so on. The instructions contained in the storage medium may be executable by any type of data processor, and are not limited to instructions executable by personal or general purpose computers.

While the present invention has been described with reference to particular embodiments, it should be understood that the embodiments are illustrative and that the scope of the invention is not limited to these embodiments. Many variations, modifications, additions and improvements to the embodiments described above are possible.

What is claimed is:

1. An electronic computer system comprising:
a server computer that executes a software application configured to enable users to trade items including clothing and accessories in non-monetary transactions, wherein the software application includes:
a user account module which is configured to track points associated with each user, wherein the user accumulates points through transactions in which items are traded away and wherein the user spends points through transactions in which items are acquired;
an auction module which is configured to enable the transactions in which items are traded away or acquired.

2. The electronic computer system of claim 1, wherein the software application further comprises a search module configured to enable users to search for items that are available to be acquired.

3. The electronic computer system of claim 2, wherein the search module is configured to automatically filter search results based upon personal information associated with a user who performs a search.

4. The electronic computer system of claim 1, wherein the software application further comprises a donation module configured to enable users to donate items to other users or charities.

5. The electronic computer system of claim 1, wherein the software application further comprises a shipping module configured to manage shipping of items involved in transactions using personal information associated with users involved in the transactions.
